(19) United States
(12) Patent Application Publication
(10) Pub. No.: US 2026/0341539 A1
(43) Pub. Date: Oct. 29, 2026

(54) Ion Transport

(71) Applicant: Gerald Peter Jackson, Lisle, IL (US)

(72) Inventor: Gerald Peter Jackson, Lisle, IL (US)

(21) Appl. No.: 19/239,285

(22) Filed: Jun. 16, 2025

Related U.S. Application Data
(62) Division of application No. 17/148,489, filed on Jan. 13, 2021, now Pat. No. 12,417,852.
(60) Provisional application No. 62/995,168, filed on Jan. 14, 2020.

(51) Int. Cl. G21B 3/00; G21B 1/11; G21B 1/13; G21G 1/10

(52) U.S. Cl. CPC G21B 3/006; G21B 1/13; G21B 1/115; G21G 1/10

(57) ABSTRACT

Articles of manufacture, machines, processes for using the articles and machines, processes for making the articles and machines, and products produced by the process of making, along with necessary intermediates, directed to the transport of ion beams.

### I. PRIORITY

This patent application is a division of U.S. patent application Ser. No. 17/148,489, filed Jan. 13, 2021, that is pending and incorporated by reference as if fully stated herein. U.S. patent application Ser. No. 17/148,489 claims priority from, and incorporates by reference as if fully stated there and herein, U.S. Patent Application Ser. No. 62/995,168 having the title “Transient Beam Compression Fusion” and filed Jan. 14, 2020 by the same inventor.

### II. SUMMARY

The disclosure below uses different prophetic embodiments to teach the broader principles with respect to articles of manufacture, apparatuses, processes for using the articles and apparatuses, processes for making the articles and apparatuses, and products produced by the process of making, along with necessary intermediates, directed to ion transport.

This Summary is further provided to introduce the idea herein that a selection of concepts is presented in a simplified form as further described below. This Summary is not intended to identify key features or essential features of subject matter, nor this Summary intended to be used to limit the scope of claimed subject matter. Additional aspects, features, and/or advantages of examples will be indicated in part in the description which follows and, in part, will be apparent from the description, or may be learned by practice of the disclosure.

References sited herein are incorporated by reference as if fully stated herein. The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

### III. INDUSTRIAL APPLICABILITY

Industrial applicability is representatively directed to that of apparatuses and devices, articles of manufacture, and processes of making and using them. Industrial applicability also includes industries, such as nuclear, engaged in the foregoing, as well as industries operating in cooperation therewith, depending on the implementation.

### IV. DRAWINGS

In the non-limiting examples of the present disclosure, please consider the following:

FIG. 1 is an illustration of a method of transporting ions;

FIG. 2 is an end view illustration of a chamber transporting energetic ions [028];

FIG. 3 is a side view illustration of a chamber transporting energetic ions, wherein the arrow indicates the propagation direction of the energetic ions and ion beam trajectory [038];

FIG. 4 is an illustration of spherically converging ion beams;

FIG. 5 is a plot of the measured cross section for neutralization of H-ions being stripped and becoming neutral atomic hydrogen.

FIG. 6 is an illustration of confinement of a central deuterium sample utilizing a radially converging spherical ion distribution;

FIG. 7 contains a plot of the calculated deceleration rate (dE/dx) of an incident deuteron through a sample of gas comprising deuterium as a function of incident deuteron kinetic energy;

FIG. 8 contains a plot of the calculated longitudinal range of an incident deuteron through a sample of gas comprising deuterium as a function of incident deuteron kinetic energy;

FIG. 9 contains a plot of the calculated deceleration rate (dE/dx) of an incident proton through a sample of gas comprising hydrogen as a function of incident proton kinetic energy;

FIG. 10 contains a plot of the calculated longitudinal range of an incident proton [088] through a sample of gas comprising hydrogen as a function of incident proton [088] kinetic energy;

FIG. 11 is an illustration of energetic ions in an ion beam propagating [040] along a trajectory into a chamber interior wherein a power supply applies a voltage between a cathode and an anode [012];

FIG. 12 is an illustration of an electrical arc [022]. The arrows indicate velocity vectors associated with free electrons [026], gas ions [024], and neutrons [036];

FIG. 13 is an illustration of the inelastic collision of two hydrogen-2 nuclei producing ions of hydrogen-3 [084], helium-3 [086], hydrogen-1 [088], and neutrons [036];

FIG. 14 is an illustration of the functional relationship between the coolant [004], the blanket [014], one or more heat exchangers [030], and a heat sink [070];

FIG. 15 is an illustration of methods comprising ion transport;

FIG. 16 is an illustration of one embodiment teaching electrical power generation;

FIG. 17 is a sketch of multiple chambers within a common bath of coolant [004];

FIG. 18 is an illustration of a lithium carbonate molecule absorbing a neutron to synthesize a predetermined isotope [062].

### V. DETAILED DISCLOSURE OF MODES

Generally, when an energetic beam of ions passes through a region filled with a gas, collisions with the electrons in the gas cause the energetic ions to lose kinetic energy, eventually coming to thermal equilibrium with the gas molecules. Often, the beam loses kinetic energy too fast, falling below a threshold needed to perform a specific function. For example, in order for boron nuclei to penetrate silicon wafers down to a prescribed depth during the process of ion implantation, they must bombard the wafer surface at a specific kinetic energy. Unless the wafer is bombarded while positioned in a vacuum, the boron beam must penetrate through a surrounding gas, often air or argon. If surrounded by a gas, the boron ion accelerator must have an increased output energy in order to account for the deceleration caused by this surrounding gas, making the accelerator more expensive than necessary.

Beams of muons can be collided to precisely study the Higgs Particle. Such muon colliders are enabled by a process wherein beams of highly-divergent muons are sent through a gas to be cooled into a tight, coherent beam. Called ionization cooling, the process depends on the fact that muons lose energy in a gas in a manner very similar to energetic ions in an ion beam. On average, each muon loses kinetic energy in its respective direction of propagation, indicating the muon momenta, both in the forward beam direction and perpendicular, are also reduced. In ionization cooling, the gas is within a radiofrequency cavity that reaccelerates the muons in the forward direction, not the original direction of the muon. The net effect is constant forward momentum but a shrinking perpendicular momentum. This generates a more collimated muon beam, hence beam cooling. A problem with this approach is that the gas-filled radiofrequency cavities are prone to voltage breakdown due to gas ionization, such that an improvement is wanting, along with a need for alternative approaches.

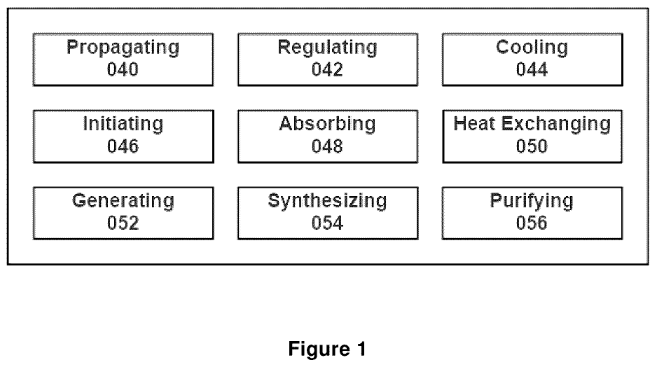

The following detailed description is directed to concepts and technologies for transport of energetic ions [028], teaching by way of prophetic illustration. As illustrated in FIG. 1, the disclosure includes a process of transporting energetic ions [028], said process comprising: propagating [040] an ion beam [008] of energetic ions [028] through a chamber that contains a gas [034]; regulating [042] pressure of said gas [034] in said chamber [032]; cooling [044] said chamber [032]; initiating [046] an electrical arc [022] within said chamber [032], said electrical arc [022] comprised of flowing gas ions [024] and free electrons [06], wherein said free electrons [026] within said electrical arc [022] are flowing; 1) in the same direction as said ion beam [008], 2) at an average velocity greater than or equal to an average velocity of said energetic ions [028], and 3) along paths at least in part spatially overlapping the trajectories of said energetic ions [028] within said ion beam [008]; absorbing [048] neutrons [036] created by said energetic ions [028] colliding with said flowing gas ions [024] and said gas [034]; and heat exchanging [050] thermal energy produced by said electrical arc [022] and said absorbing [048]. In another embodiment, this process also comprises generating [052] electrical power [060] with said thermal energy from said heat exchanging [050]. In yet another embodiment, this process also comprises synthesizing [054] one or more predetermined isotopes [062] with neutrons [036] from said absorbing [048]. In yet another embodiment, this process also comprises purifying [056] said gas [034] to remove one or more predetermined isotopes [062] from said chamber [032].

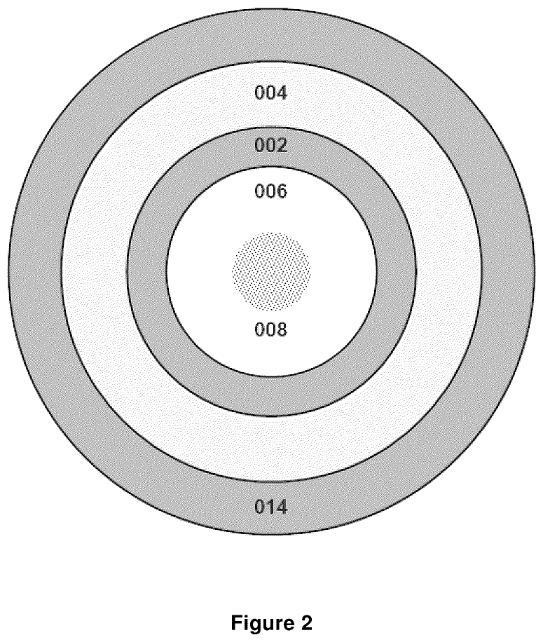

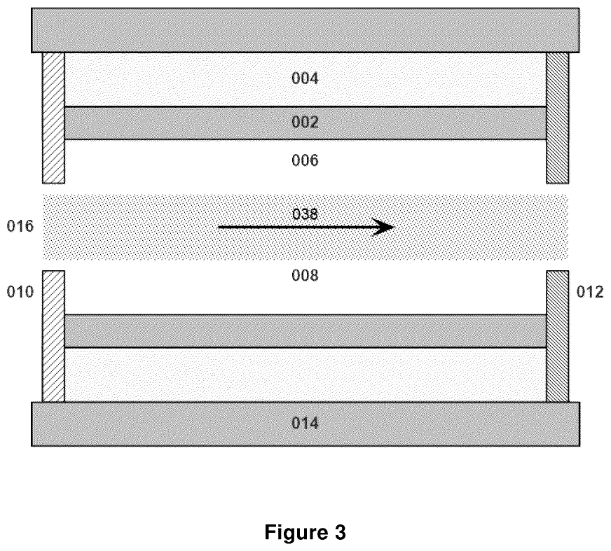

The following disclosure includes a teaching of product produced by a process. Similarly, as illustrated in FIG. 2 and FIG. 3, the following disclosure teaches an apparatus to transport energetic ions [028], said apparatus including: an entrance port [016] configured to transmit energetic ions [028] in an ion beam [008]; a chamber [032] connected to said entrance port [016], said chamber holding a gas [034] that allows ion beam [008] propagation through said gas [034] along an ion beam trajectory [038]; a cathode [010] within said chamber [032] proximate to said entrance port [016] and said ion beam trajectory [038]; an anode [012] within said chamber [032] arranged downstream of said cathode [010] along said ion beam trajectory [038]; a gas pressure regulator [020] configured to bring about a specified pressure of said gas [034] within said chamber [032]; a coolant [004] exterior to said chamber [032] configured to maintain a specified temperature within said chamber [032]; a power supply [018] in electrical communication with said cathode [010] and said anode [012], configured to provide a voltage and current maintaining an electrical arc [022] within said chamber [032], such that when said electrical arc [022] is comprised of gas ions [024] and free electrons [026] originating from said gas [034], said free electrons [026] within said electrical arc [022] 1) flow away from said cathode [010] and toward said anode [012] at an average velocity greater than or equal to an average velocity said energetic ions [028], and 2) flow along paths that at least partially spatially overlap said trajectory [038] of said ion beam [008]; a blanket [014] proximate to said chamber [032] and arranged to absorb [048] neutrons [036] created by said energetic ions [028] colliding with said gas ions [024] and said gas [034], said blanket [014] comprised of at least one material that has a higher neutron [036] absorption cross section than at least one the material comprising said coolant [004]; and one or more heat exchangers [030] in thermal communication with said coolant [004], said blanket [014], or both. These are indicative of how to make such an apparatus as well as necessary intermediates produced in the methods.

### A. Spherical Confinement

In one embodiment in a quasi-spherical architecture, solid deuterium is exposed to spherically converging negative deuterium ion beams, creating a central shell of high temperature deuterons surrounded by a neutralizing cloud of electrons. This plasma is confined by scattering plasma ions and electrons against the incoming ion beams, undergoing traditional dE/dx in the frame of the converging ion beams.

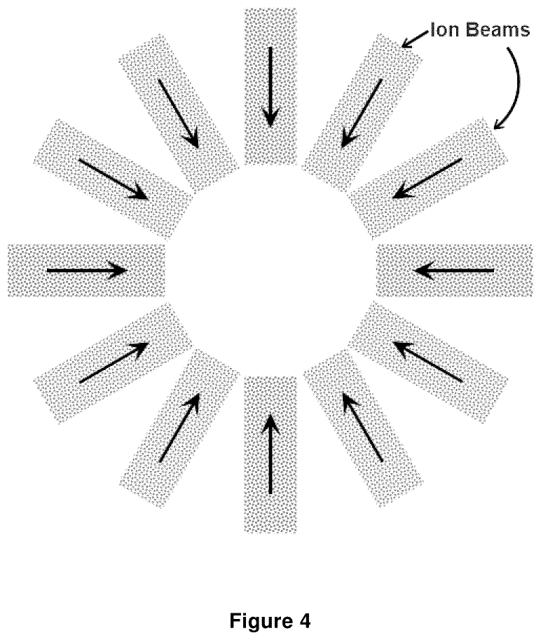

In the past, multiple ion beams have been used to mimic the spherical convergence of ions at the heart of classic inertial electrostatic confinement reactors. Using six converging ion beams, such devices have resulted in the copious generation of neutrons [036]. A quasi-spherical architecture serving as an embodiment is not limited to six beams, but enough beams to sufficiently mimic a spherical geometry that can be assessed and accurately validated. Configurations wherein many more than six, such as hundreds of small beams, are envisioned that converge at a central region. Illustratively, see FIG. 4.

Using a Green's Function approach to analyzing pulsed operations, synchronously pulsing these beams forms an infinitesimally thin spherical charged shell collapsing toward a central focal point. For ions of individual charge q and initial kinetic energy K, energy conservation requires that a shell of total charge Q will stop at a radius Rₘᵢₙ defined by the equation:

$${R}_{min} = \frac{1}{2} \frac{q Q}{4 π {ε}_{o} K} \qquad ( 1 )$$

These shells were originally termed poissors by Farnsworth in U.S. Pat. Nos. 3,258,402 and 3,386,883, both incorporated by reference in their entirety as if fully restated herein. In continuous beam conditions this surface of minimum radius is called a virtual anode or cathode (depending on the charge of the beam). For example, in the case of 100 keV deuterons a thin shell with a total charge of 0.1 Coulombs starting at a radius of 20 cm takes 65 ns to reach an Rₘᵢₙ of 0.5 cm, and then another 65 ns to travel back to the starting radius.

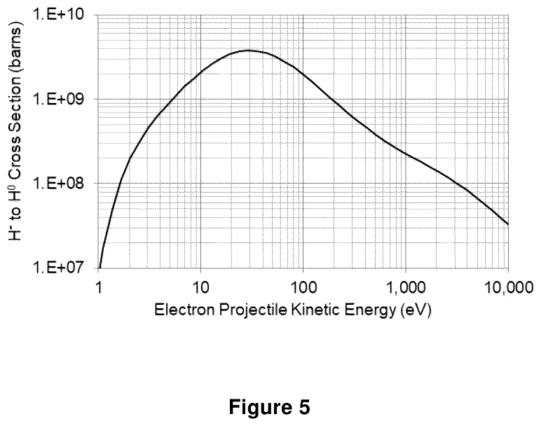

In an embodiment, a microsecond pulse of hundreds of negative deuterium ion beams converge toward the center. At Rₘᵢₙ these beams stop and travel back through themselves. If these beams are intense enough, the electrons orbiting the rebounding ions will partially strip some the incoming ions, causing some of the ions to neutralize (for a 100 keV ion beam the orbiting electrons have kinetic energies of approximately 25 eV). Note in FIG. 5 that this cross section for ionization is nine orders of magnitude larger than the fusion cross section, and 25 eV is near the peak cross section. The inbound neutral atoms will continue through Rₘᵢₙ toward the radial center of the geometry. For a given beam current the particle density at Rₘᵢₙ scales as the square of that radius.

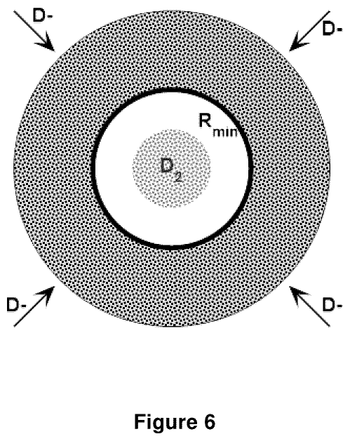

As per FIG. 6, assume that centered within Rₘᵢₙ there is an ensemble of deuterium molecules large enough to cause the charged products formed by DD collision events to stop and give up their ~1 MeV of kinetic energy to the surrounding molecules. This ensemble is the fuel that provides the raw material for energy gain, breakeven energy generation, and neutron production. Because neutrons [036] are not charged, they will leave this ensemble without transferring much of their 2.4 MeV of kinetic energy to the molecules. Similarly, the 3 MeV protons are too energetic and do not interact enough with the molecules to give up an appreciable amount of their kinetic energy. Therefore, each reaction event heats the ensemble by an amount of 1 MeV.

The radially in-flowing deuterium ions that are neutralized enter this ensemble and induce some deuterium-deuterium reaction events, but mostly give up their 100 keV of kinetic energy. These neutral atoms are completely stripped of electrons in the process, and the deuterium molecules dissociate, and their constituent atoms also begin to ionize. In a traditional Fusor, inbound ions and electrons are both accelerated to keV energy levels, creating nested shells of virtual anodes and cathodes. However, in this case the velocity of the electrons is the velocity of the deuterium ions, and hence the initial electron kinetic energies at the moment of ionization is on the order of 25 eV (at the peak of the ionization curve in the data plotted in FIG. 6). In addition, during the ionization process the electrons are scattered by large angles, indicating they are born with large angular momentum with respect to the ensemble center. This means that instead of creating an internal virtual cathode, the electrons orbit the center and form a neutralizing halo around the increasing large ensemble of positively charged deuterons. The central deuterons then proceed to generate a positively charged poissor that attracts and subsumes the original negatively charged shell at Rₘᵢₙ.

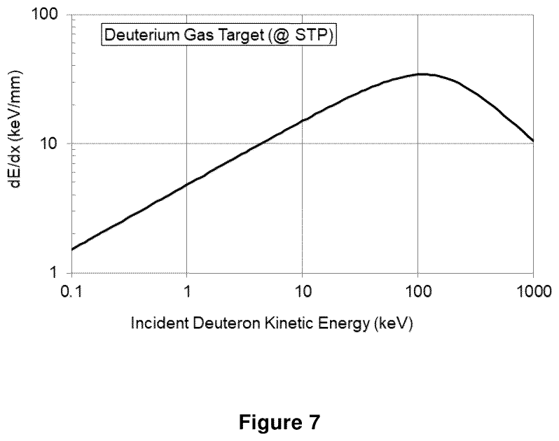

At low deuterium beam densities, the deuterons would escape the poissor and be lost. At high enough ion beam particle densities, the deuterons act as incident projectiles entering the incoming negative deuterium ion beams in their relative rest frame. Like spitting into the wind, the deuterons suffer a high enough dE/dx that they reverse trajectory and are essentially confined. The deceleration due to dE/dx (see FIG. 7) can be treated as a force, which in turn is an external pressure on the central deuteron plasma. On the radial inside an equal electrostatic pressure pushes the deuterons outward. This compression is enough to create gain as long as the entire thickness and density of deuterons (and electrons) is enough to range out the DD reaction products.

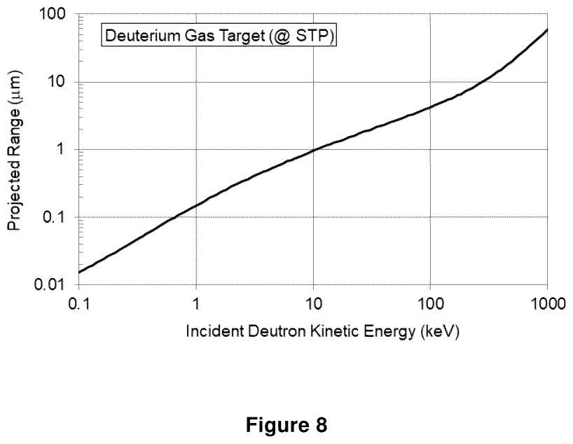

A sufficient density of deuterons and incoming negatively charged deuterium ions is possible for small enough Rₘᵢₙ and high enough ion beam current. An ion beam density comparable to that of deuterium gas at STP conditions would be more than enough (see FIG. 8). In fact, much lower densities are feasible. The combination of poissor radius, average negative deuterium ion beam source current, and pulse compression technology can produce enough peak density to satisfy the above criteria.

### B. Neutral Gas

When an incident molecule or atom travels through a gas at a kinetic energy much higher than the random kinetic energies of the gas molecules that constitutes thermal motion, the incident molecule or atom becomes quickly ionized, eventually being stripped of all orbiting electrons. For an energetic hydrogen atom incident on a region filled with gas, the atom quickly loses its orbiting electron and simply becomes an incident proton [088] through the remainder of the gas. For an energetic deuterium atom incident on a region filled with gas, the atom quickly loses its orbiting electron and simply becomes an incident deuteron [090] through the remainder of the gas. A molecule or atom that has a different number of orbiting electrons than protons in the nuclei is called an ion.

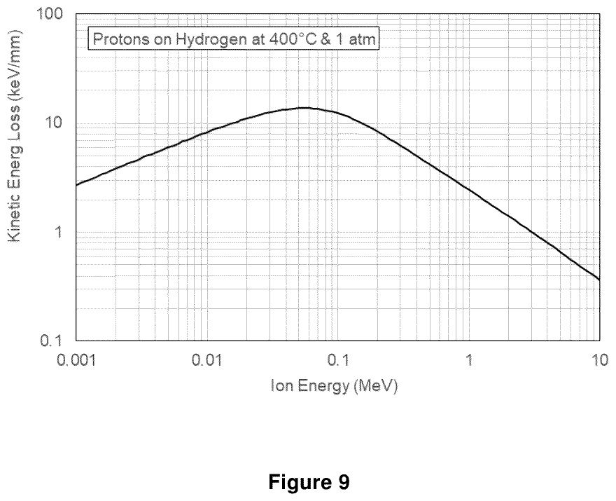

As the incident proton [088] or deuteron [090] travels through the gas [034], it collides with the gas electrons. These collisions steal kinetic energy from the incident particle. The rate of energy loss with distance is referred to as dE/dx. The quantity dE/dx is a change of kinetic energy with distance, which is a force. When this force is divided by the particle mass, an acceleration is suffered by the particle. In this case the acceleration is negative, so it is also called deceleration. This loss rate is a function of the kinetic energy of the incident particle. FIG. 7 contains a plot of this energy loss rate for deuterons [090] incident on deuterium gas at STP conditions. FIG. 9 contains a plot of this energy loss rate for protons incident on hydrogen gas at atmospheric pressure but at a temperature of 400 °C. In this application the term “energetic ion” [028] is synonymous with the term “incident particle”.

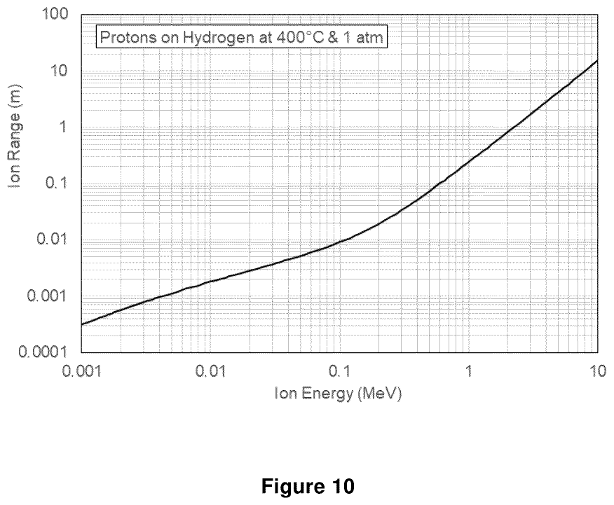

For an energetic ion [028] of a given initial kinetic energy, the distance that the energetic ion [028] travels through a gas [034] before coming to rest is called the longitudinal range. The longitudinal range is a strong function of the initial kinetic energy, as shown for deuterons propagating through deuterium in FIG. 8 and protons propagating though hydrogen gas in FIG. 10.

The previous section concerning spherical confinement teaches that the physics of dE/dx, and hence energetic particle [028] acceleration, does not depend on the frame of reference of the interaction. A 1 MeV proton [088] suffers the same deceleration in a stationary gas [034] as the acceleration a stationary proton [088] suffers in the presence of a 1 MeV gas “wind” (a moving gas volume wherein the constituent atoms have an average kinetic energy in a given direction of 1 MeV). Eventually, within the range distance of the proton [088] relative to the wind, the proton velocity will match the average velocity of the wind.

Since the orbiting electrons of the gas [034] are the dominant source of dE/dx calculated in FIG. 7 and FIG. 9, it is the kinetic energy of these electrons in the wind that are accelerating the proton [088], not the nuclei within the molecules comprising the gas [034]. Kinetic energy of a particle is equal to one half of the particle mass times the square of the particle velocity. When discussing the interaction between a gas [034] and an energetic particle [028], it is the relative velocity between the electrons in the gas [034] and the energetic particle [028] that determines the rate of change in that relative velocity with distance due to dE/dx.

### C. Gas Discharge

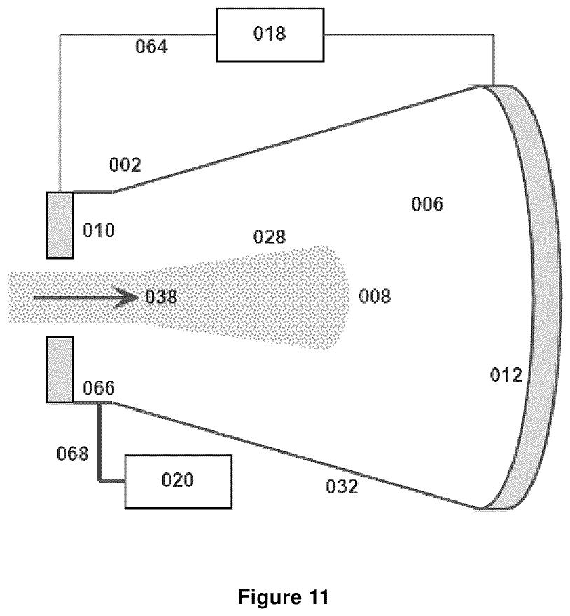

In one embodiment illustrated in FIG. 11, two electrodes immersed in a gas [034] contained by a chamber [032] have a voltage applied between them. The ratio of this voltage with the distance between the electrodes determines an electric field. The electrode with the lower (more negative) voltage acts as a cathode [010]. The electrode with the higher (more positive) voltage acts as an anode [012]. The voltage is applied between the cathode [010] and anode [012] by connecting them to a power supply [018] using electrical cables [064]. At low electric fields the gas [034] acts as an insulator, and very little electrical current is measured between the anode [012] and cathode [010]. Stray radiation, such as cosmic rays, will release small numbers of free electrons [026] when striking the cathode [010]. A free electron [026] is any electron not bound to a nucleus in the form of an atom or molecule.

Negatively-charged free electrons [026] are accelerated away from the cathode [010] and toward the anode [012]. If between collisions the kinetic energy of free electrons [026] grows sufficiently large to ionize the gas [034] molecules and/or atoms, more free electrons [026] are generated. One cross section (proportional to probability) of such ionization is plotted in FIG. 5 as a function of free electron [026] kinetic energy. At a breakdown voltage which depends on the pressure and composition of the gas [034], the density of free electrons [026] grows with time and distance, converting the gas from an insulator to an electrical conductor. At the same time, gas ions [024] are accelerated away from the anode [012] and toward the cathode [010]. The flow of gas ions [024] and free electrons [026] constitutes an electrical current. This process of ionization and current conduction are indicative of a gas discharge. An intense gas discharge wherein the level of ionization is greater than 0.1% is called an electrical arc [022].

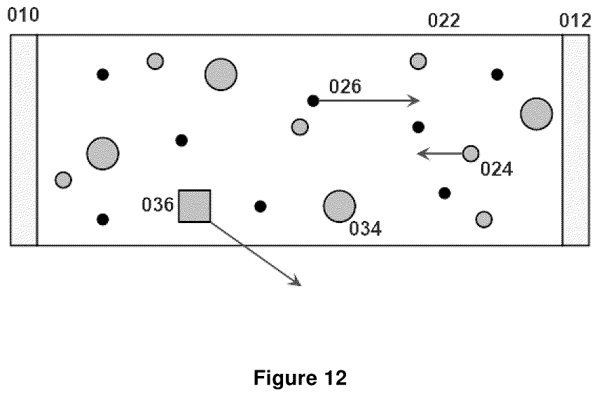

FIG. 12 is an illustration of an electrical arc [022] comprising molecules of gas [034], free electrons [026], gas ions [024], and neutrons [036]. Illustrative velocity vectors induced by the electric field generated by the cathode [010] and anode [012] are also indicated for the free electrons [026] and gas ions [024]. In the case of neutrons [036] formed by reactions between energetic ions [028] and said molecules of gas [034] or gas ions [024], a random velocity vector is also indicated.

When the gas ions [024] flowing toward the cathode [010] strike the cathode [010], they induce more free electrons [026] by the process of secondary electron emission. The kinetic energy of the gas ions [024] are transferred to the electrode material of the cathode [010] in the form of heat. As the temperature of the cathode [010] increases, additional free electrons [026] flow out of the cathode [010] by the process of thermionic emission.

### D. Deceleration Compensation

When the energetic ions [028] within an ion beam [008] are transported through a gas [034], the energetic ions [028] lose kinetic energy due to collisions with the bound electrons that are orbiting the atoms comprising the gas [034]. The loss of kinetic energy constitutes deceleration of both the ion beam [008] and the energetic ions [028].

In one embodiment, the gas [034] is ionized by initiating an electrical arc [022], the electrical arc [022] comprised of free electrons [026] flowing in the same direction as an incident ion beam [008], and positively charged gas ions [024] flowing in the opposite direction, wherein said free electrons [026] have an average velocity greater than the energetic ions [028] within said ion beam [008]. In this embodiment, assume that the gas [034] is composed of hydrogen at a pressure of 760 Torr (one bar or one atmosphere) and a temperature of 400 °C, as calculated in FIG. 9. Also assume that the energetic ions [028] of the ion beam [088] have an average kinetic energy of 2 MeV and comprise protons [088]. Under these conditions the velocity of the protons is 0.065c (6.5% of the speed of light). If the average velocity of the free electrons [026] in the moving frame of the energetic ions [028] is 0.43c (43% of the speed of light), the relative kinetic energy of those free electrons [026] is 55 keV. In the laboratory frame (stationary with respect to the chamber [032]), the average velocity of the free electrons [026] in this embodiment is approximately 0.495c. This free electron [026] velocity corresponds to a kinetic energy of 77 keV in the laboratory frame. Also, in this embodiment assume that the fraction of ionized atoms within the gas [034] is 10% (the density of gas ions [028] is one tenth of the density of neutral atoms in the gas [034]).

According to the FIG. 9, a 2 MeV ion beam comprising protons suffers a deceleration rate of 1.4 keV/mm when the gas is not ionized. Similarly, a 55 keV beam of protons suffers a deceleration rate of 13.62 keV/mm. In the above embodiment with 10% ionization, the remaining 90% of neutral atoms in the gas [034] cause a deceleration rate of 1.26 keV/mm. On the other hand, assuming that free electrons [026] have the same effect on energetic ions [028] as electrons bound in neutral atoms, the 10% density of free electrons [26] in the electrical arc [022] cause an acceleration rate of 13.62*0.1=1.36 keV/mm. Therefore, under the conditions of the above embodiment, the electrical arc [022] reverses dE/dx from deceleration to a net acceleration of the ion beam [008] of approximately 0.1 keV/mm.

In general, the assumption that free electrons [026] impose the same dE/dx as bound electrons is known to not be rigorously true. Under most relevant conditions, free electrons [026] induce a greater dE/dx on an incident ion beam [008] than bound electrons in a cold gas [034]. This difference depends on the composition of the gas, density, and temperature.

### E. Thermal Control

There are many mechanisms that deposit thermal energy into a chamber [032] such as that illustrated in FIG. 2, FIG. 3, and/or FIG. 11. This deposited thermal energy causes the temperature of the chamber [032] to increase. Maintenance of a specified temperature within the chamber [032] is performed by cooling [044] the chamber [032].

In one embodiment in which the ion beam [008] does not exit the chamber [032], all of the total kinetic energy of the ion beam [008], the summation of the kinetic energy of each energetic ion [028] within the ion beam [008], is deposited into the chamber. In an embodiment, an ion beam [088] with an electrical current of 3 Amperes composed of energetic ions [028] with an average kinetic energy of 2 MeV, the deposited thermal power is 6 MW.

In the embodiment illustrated in FIG. 11, a power supply [018] sourcing 500 Amperes of electrical current at a voltage between the cathode [010] and anode [012] of 10,000 Volts deposits a thermal power of 5 MW into the chamber [034] while initiating [046] and maintaining an electrical arc [022].

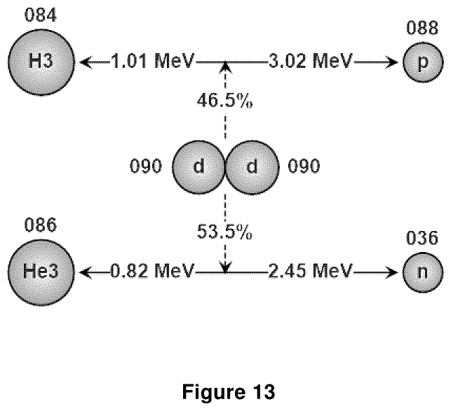

In an embodiment wherein the gas [034] contains at least some deuterium and the incident energetic ions [028] in the ion beam [008] contain at least some hydrogen-2 ions [090], inelastic collisions between deuterium atoms and said hydrogen-2 ion [090] can synthesize [054] neutrons [036] and the ions hydrogen-1 [088], hydrogen-3 [084], and helium-3 [086]. This inelastic collision process is illustrated in FIG. 13. These inelastic collisions release excess energy in the form of kinetic energy of neutrons [036] and ions of hydrogen-1 [088], hydrogen-3 [084], and helium-3 [086], as taught in U.S. provisional patent application 63/070,587 filed on Aug. 26, 2020 and invented by the inventor of this instant application. Provisional patent 63/070,587 titled “Mixed Nuclear Power Conversion” is incorporated herein by reference as if fully stated herein. Since the isotopes are positively charged, they stop within the gas [034] or chamber wall [002]. This excess energy is another mechanism for the deposition of thermal energy into the chamber [034]. In this embodiment, an inelastic collision rate capable of synthesizing [054] 500 grams of helium-3 [086] per year would continuously deposit approximately 3.7 MW of thermal power into the chamber [032].

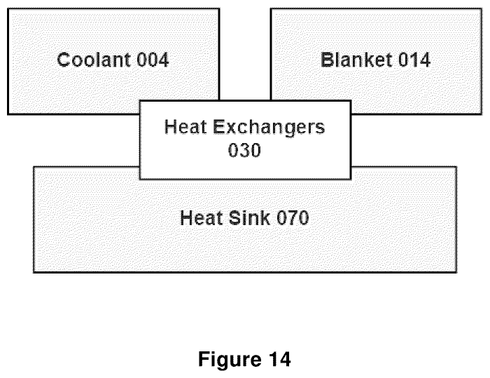

In the embodiment illustrated in FIG. 2 and FIG. 3, a coolant [004] in placed in thermal communication with the chamber wall [002]. While cooling [044] the chamber (i.e. removing thermal energy), the temperature of the coolant [004] is lower than the temperature of the chamber wall [002]. In one embodiment illustrated in FIG. 14, one or more heat exchangers [030] transfer thermal energy from said coolant [004] to an external heat sink [070]. Passive thermal communication provides cooling as long as the temperature of the external heat sink is lower than the temperature of the coolant [004].

Accordingly, the one or more heat exchangers [030] can transfer thermal energy from a coolant [004] to an external heat sink [070] and in some, but not all applications, a radiator comprises said external heat sink [070], transferring said thermal energy into air.

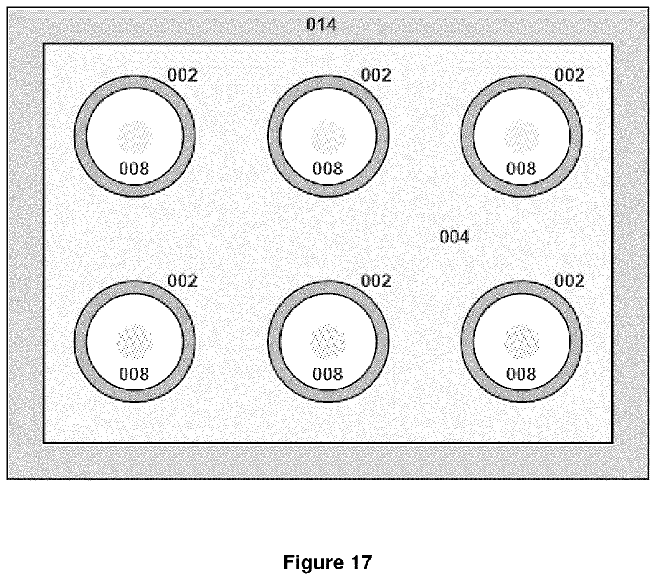

In an embodiment illustrated in FIG. 17, multiple chambers [032] encased in individual chamber walls [002], each transporting separate ion beams [008], can be cooled by a common bath of coolant [004]. Neutrons [036] from each of these ion beams [008] can be absorbed [048] by either a common blanket [014], or several blankets [014] in proximity to the chambers [032].

### F. Blanket

Working within the same embodiment, the neutrons [036] that are produced by the inelastic collisions generally pass through the gas [034] and chamber wall [002]. The emission of energetic neutrons [036] into the environment and nearby personnel can cause damage and death. A blanket [014] is used in some embodiments to moderate and absorb [048] these neutrons [036], as taught as taught in U.S. provisional patent application 63/036,073 filed on Jun. 8, 2020 and co-invented by the inventor of this instant application. Provisional patent 63/036,073 titled “Sulfur Blanket” is incorporated herein by reference as if fully stated herein.

In some embodiments the absorption [048] of a neutron [036] by a material within the blanket [014] can release a significant amount of excess energy in the form of particle kinetic energy and gamma-rays. When this excess energy is also contained by the blanket [014], significant amounts of thermal power is generated in some embodiments. In one embodiment, the inexpensive and plentiful compound lithium carbonate [082] can have a high average cross section for absorbing [048] neutrons [036]. Lithium carbonate [082] is an inorganic compound, the lithium salt of carbonate with the formula Li₂CO₃. This white salt is widely used in the processing of metal oxides and treatment of mood disorders. For the treatment of bipolar disorder, Li₂CO₃ is on the World Health Organization's List of Essential Medicines, the most important medications needed in a basic health system. Lithium carbonate [082] has a melting point of 723 °C, much higher in temperature than typical steam temperatures in electrical generator plants.

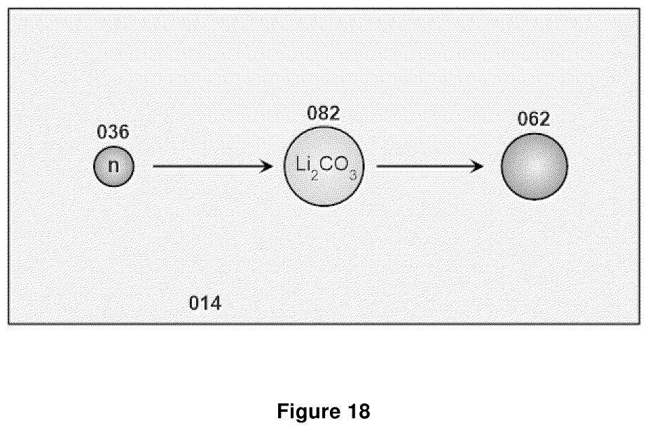

In one embodiment illustrated in FIG. 18, a blanket [014] composed, at least in part, of lithium carbonate [082] is used to moderate and absorb [048] neutrons [036] that are created by inelastic collisions in the proximity of the blanket [014]. Absorbing [048] a neutron [036] with specific atoms within the blanket [014], such as lithium atoms within lithium carbonate molecules [082], can generate predetermined isotopes [062] that in some embodiments undergo subsequent extracting [100], storing [102], and/or transporting [104]. In this context, the term “predetermined” refers to the fact that the entire design of the chamber [032], selection of the gas [034], and selection of the materials within the blanket [014] were optimized to increase the production rate of that specific predetermined isotope [062]

In an embodiment wherein inelastic collisions occur at a rate sufficient to produce 500 grams/yr of the isotope helium-3 [086] within the chamber [032], a sufficient number of neutrons [036] are absorbed [048] to also synthesize [054] 500 grams/yr of hydrogen-3 [084] within the blanket [014]. At this rate of synthesis [054], the energy released by the absorption [048] of the neutrons [036] would generate 2.4 MW of thermal power in the blanket [014].

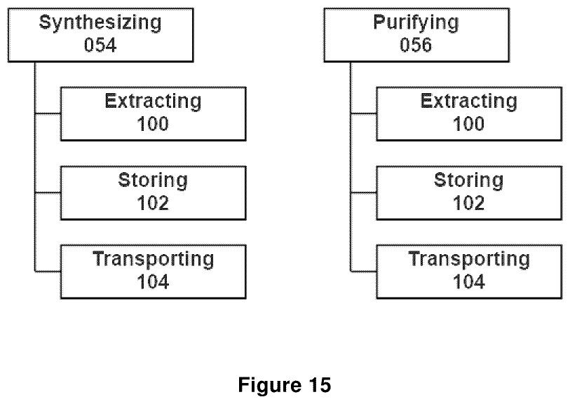

In summary, as illustrated in FIG. 15, this application teaches a process of transporting energetic ions [028] comprising synthesizing [054] one or more predetermined isotopes [062] with neutrons [036] from said absorbing [048]. In addition, this application teaches a process further comprising extracting [100] one or more of said predetermined isotopes [062]. In addition, this application teaches a process further comprising storing [102] one or more of said predetermined isotopes [062]. In addition, this application teaches a process further comprising transporting [104] one or more of said predetermined isotopes [062].

In the embodiment illustrated in FIG. 2 and FIG. 3, a coolant [004] is placed in thermal communication with the blanket [014]. While cooling [044] the chamber (i.e. removing thermal energy), the temperature of the coolant [004] is lower than the temperature of the blanket [014]. In one embodiment illustrated in FIG. 14, one or more heat exchangers [030] transfer thermal energy from said coolant [004] to an external heat sink [070]. Passive thermal communication provides cooling [044] as long as the temperature of the external heat sink [070] is lower than the temperature of the coolant [004].

### G. Purification

In general, the composition of the incident energetic ions [028] in an ion beam [008] is different from the composition of the gas [034] within the chamber [032]. Because of incomplete deceleration compensation, deflection of energetic ions [028] out of the electric arc [022], an embodiment such as that illustrated in FIG. 11 wherein there is no exit from said chamber [032], or other predetermined isotopes [062] synthesized [054] by inelastic collision between the energetic ions [028] and the gas [034], the gas [034] accumulates impurities that adversely impact initiating [046] the electric arc [022], deceleration compensation, and/or synthesizing [054] predetermined isotopes [062].

In an embodiment such as that illustrated in FIG. 11, one or more gas feedthroughs [066] penetrate the chamber wall [002]. To these gas feedthroughs [066] are connected one or more gas conduits [068] that are in turn connected to one or more gas pressure regulators [020]. The gas pressure regulator [020] supplies fresh gas [034], maintains the pressure of the gas [034], and filters the gas [034] to remove impurities.

In summary, as illustrated in FIG. 15, this application teaches a process of transporting energetic ions [028] comprising purifying [056] said gas [034] to remove one or more predetermined isotopes [062] from said chamber [032]. In addition, this application teaches a process further comprising extracting [100] one or more of said predetermined isotopes [062]. In addition, this application teaches a process further comprising storing [102] one or more of said predetermined isotopes [062]. In addition, this application teaches a process further comprising transporting [104] one or more of said predetermined isotopes [062].

### H. Electricity Generation

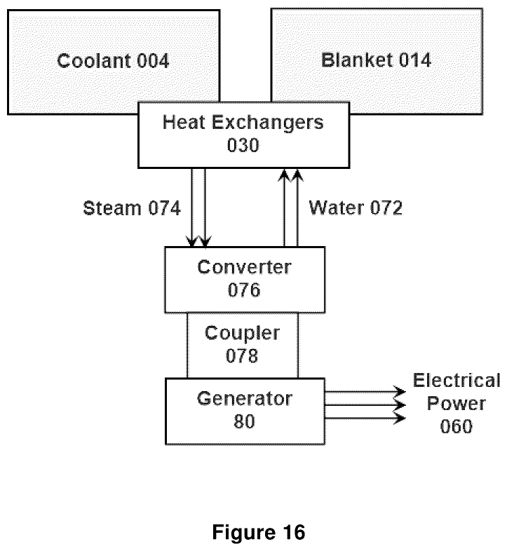

In one embodiment illustrated in FIG. 16, the process step of heat exchanging [050] can be employed for the generation of electrical power [060]. The apparatus starts with a heat exchanger [050] in thermal contact with the blanket [014] and or coolant [004]. By heating a cooling liquid [072] in the heat exchanger [076] to form a high pressure vapor [074], a converter [076] converts the mechanical potential energy of the vapor [074] into electrical power [060] in an electrical generator [080] connected to said converter [076] by a coupler [078]. The efficiency of the step of converting heat into electrical power [060] is enhanced by surrounding the blanket [014] with thermal insulation.

In one embodiment the cooling liquid [072] is water, the high pressure vapor [074] is steam, the converter [076] is a turbine, the coupler [078] is a drive shaft, and the electrical generator [080] is a standard electrical generator or alternator. In another embodiment the converter [076] is a thermoelectric element, the coupler [078] is copper wire, and the electrical generator [080] is a DC-AC converter.

Accordingly, one or more electrical generators [080] can be connected to said one or more heat exchangers [030], and in some, but not all applications, there can be a process comprising generating [052] electrical power [060] with said thermal energy from said heat exchanging [050].

### I. Statement of Scope

In sum, it is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Variation from amounts specified in this teaching can be “about” or “substantially,” so as to accommodate tolerance for such as acceptable manufacturing tolerances.

The foregoing description of illustrated embodiments, including what is described in the Abstract and the Modes, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

1. An apparatus including:
an entrance port configured to transmit energetic ions in an ion beam;
a chamber connected to said entrance port, said chamber holding a gas that allows ion beam propagation through said gas, said ion beam propagation along an ion beam trajectory;
a cathode within said chamber proximate to said entrance port and said ion beam trajectory;
an anode within said chamber arranged downstream of said cathode along said ion beam trajectory;
a gas pressure regulator configured to bring about a specified pressure of said gas within said chamber;
a coolant exterior to said chamber configured to maintain a specified temperature within said chamber;
a power supply in electrical communication with said cathode and said anode, configured to provide a voltage and current maintaining an electrical arc within said chamber, such that when said electrical arc is comprised of gas ions and free electrons originating from said gas, said free electrons within said electrical arc:
flow away from said cathode and toward said anode at an average velocity greater than or equal to an average velocity of said energetic ions; and
flow along paths that at least partially spatially overlap said trajectory of said ion beam;
a blanket proximate to said chamber and arranged to absorb neutrons created by said energetic ions colliding with said gas ions and said gas, said blanket comprised of at least one material that has a higher neutron absorption cross section than at least one material comprising said coolant; and
one or more heat exchangers in thermal communication with said coolant, said blanket, or both.

2. The apparatus of claim 1, wherein the one or more heat exchangers transfer thermal energy from said coolant to an external heat sink.

3. The apparatus of claim 2, wherein a radiator comprises said external heat sink, transferring said thermal energy into air.

4. The apparatus of claim 1, further including one or more electrical generators connected to said one or more heat exchangers.

5. The apparatus of claim 1, wherein two or more chambers are placed within a single bath of coolant, each chamber transporting a separate ion beam.

6. A process comprising:
propagating an ion beam of energetic ions through a chamber that contains a gas;
regulating pressure of said gas in said chamber;
cooling said chamber;
initiating an electrical arc within said chamber, said electrical arc comprised of flowing gas ions and free electrons, said free electrons within said electrical arc flowing;
in the same direction as said ion beam;
at an average velocity greater than or equal to an average velocity of said energetic ions; and
along paths at least in part spatially overlap trajectories of said energetic ions within said ion beam;
absorbing neutrons created by said energetic ions colliding with said flowing gas ions and said gas; and
heat exchanging thermal energy produced by said electrical arc and said absorbing.

7. The process of claim 6, further comprising generating electrical power with said thermal energy from said heat exchanging.

8. The process of claim 6, further comprising synthesizing one or more predetermined isotopes with neutrons from said absorbing.

9. The process of claim 8, further comprising extracting one or more of said predetermined isotopes.

10. The process of claim 8, further comprising storing one or more of said predetermined isotopes.

11. The process of claim 8, further comprising transporting one or more of said predetermined isotopes.

12. The process of claim 6, further comprising purifying said gas to remove one or more predetermined isotopes from said chamber.

13. The process of claim 12, further comprising storing one or more of said predetermined isotopes.

14. The process of claim 12, further comprising transporting one or more of said predetermined isotopes.

15. A process comprising:
propagating an ion beam of energetic ions through a chamber that contains a gas;
regulating pressure of said gas in said chamber;
cooling said chamber;
initiating an electrical arc within said chamber, said electrical arc comprised of flowing gas ions and free electrons, said free electrons within said electrical arc flowing;
in the same direction as said ion beam;
at an average velocity greater than or equal to an average velocity of said energetic ions; and
along paths at least in part spatially overlap trajectories of said energetic ions within said ion beam;
absorbing neutrons created by said energetic ions colliding with said flowing gas ions and said gas;
heat exchanging thermal energy produced by said electrical arc and said absorbing; and
simultaneously producing more than one product by the process, wherein one of the products is electrical power.

16. A product produced by the process of claim 14, wherein said more than one product by the process comprises a synthesized, predetermined isotope with neutrons from said absorbing.

17. A product produced by the process of claim 14, wherein said more than one product by the process comprises a quantity of hydrogen-3 atoms.
